(19) United States
(12) Patent Application Publication
(10) Pub. No.: US 2010/0037726 A1
(43) Pub. Date: Feb. 18, 2010

(54) FOOT PEDAL MODULE

(75) Inventor: Werner BECK, Amberg (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/512,193

(22) Filed: Jul. 30, 2009

(30) Foreign Application Priority Data
Aug. 13, 2008 (DE) 10 2008 038 808.4

(51) Int. Cl. G05G 1/30

(52) U.S. Cl. 74/514

(57) ABSTRACT

A foot pedal module (1) including an enclosure (3), a rotor (11), a foot pedal (15), two springs (17, 19) and a circuit board (33). The enclosure (3) has a trunnion (5), an outer ring (29) and a cover (39) for accommodating and protecting the rotor (11). The rotor (11) is linked with a bushing (7), a tappet, a lever (13), two haptic springs (17, 19), two damping elements (21, 23) and a driving element (27). The circuit board (33) carries an inductor array (25) which are designed as flat coils and located opposite the damping elements (21, 23). The foot pedal (15) is linked to the lever (13) and bushing (7) by a ball joint (35) and a socket (27).

This application claims priority from German patent application serial no. 10 2008 038 808.4 filed Aug. 13, 2008.

### FIELD OF THE INVENTION

The invention refers to a foot pedal module.

### BACKGROUND OF THE INVENTION

Known as state of the art is, for instance, a configuration as described in DE 10 2005 061 277 A1, which is the basis of this invention. It describes a vehicle's accelerator pedal, comprising the following components:
a basis part for a permanent installation in a vehicle,
a pedal part, which can, with respect to the basis part, be pivoted around a pivot axle,
an inductive sensor determining the pedal part's position, comprising an inductor configuration circuit mounted at the basis part, at least one sensor coil and at least one receiver coil, and a coupling part which moves in front of the coil configuration circuit upon the pedal part's movement,
a lever part, which is positioned at the basis part's axle part, pivotable around a lever's pivot axle, and being coupled in a way with the pedal part, so that the lever part pivots in relationship to the basis part upon activation of the pedal part,
whereby the pedal pivot axle is positioned distant and in parallel to the lever pivot axle, and the coupling part is attached to the lever part.

In addition, an accelerator pedal configuration for vehicles is known through DE 20 2004 004 454 U1. It is particularly designated for passenger automobiles and comprises:
an accelerator pedal module, in which an accelerator pedal and a base plate which are movable relative to each other in at least one pivot point,
a linear encoding unit, in which two segments are moved relative to each other,
the one segment is mounted at the accelerator pedal, and the other segment being mounted at the base plate, and being designed in the shape of a partial circle,
in the one segment, being a moving part, a torque motor sliding part is positioned, having arranged several, consecutive and one after the other permanent magnets, and in the other segment, being a stationary part, a torque motor stator part, having arranged several, consecutive and one after the other, field windings,
and in one segment, in addition to the permanent magnets, a resonant circuit with at least one capacitor and one inductor are provided, and in the other segment, in addition to the field coils, at least three coils of the sensor's inductor circuit is provided.

Also, known through DE 20 2004 004 457 U1 is an additional accelerator pedal configuration for vehicles. The configuration comprises at least one sensor and one accelerator module, which is incorporates at least one accelerator pedal. By means of the accelerator pedal, a resonant circuit is altered between an actuation position and a non-actuation position in a way so that a corresponding signal is generated. The resonant circuit comprises at least one capacitor and at least one inductor which are shifted by means of the sensor's coil circuitry, comprising at least three coils.

Known from DE 102 55 712 A1 is an additional accelerator pedal construction for a vehicle. It comprises a contactless linear sensor, which incorporates a cursor part and a stator part. The linear sensor is being linked in a way to an accelerator pedal lever, so that the cursor part is coupled, free of play, to the accelerator pedal lever by means of a tappet.

At last, as described in DE 101 33 194 A1, an accelerator pedal construction to adjust the vehicle's driving speed is known, comprising
an accelerator pedal plate
at least one spring, which generates a reset force at the accelerator pedal plate
a linking part which transfers the accelerator pedal plate's movement to the spring,
at least one sensor, which generates a signal, depending on the accelerator pedal plate's activation, and which is a linear distance sensor,
a friction part to generate a force hysteresis at the activation of the acceleration pedal plate, whereby the link is being guided by an (preferably rectangular) angled cast form at an enclosure and re-directing the movement of the accelerator pedal plate.

### SUMMARY OF THE INVENTION

The purpose of this invention is the development of a foot pedal module, which is also based on inductive sensor technique and which, under simple manufacturing conditions, can transfer precisely the foot pedal's angular position.

Different from the state of the art, the perimeter area of the lever part or the rotor is not being used, but instead the rotor's front face, to attach the coupling part or the activator part. Thus, the geometric form of the activator parts, also avoiding a delicate dependence on distance issues, are much more easily matched to the shape of the inductor arrays. The category defining state of the art in DE 10 2005 061 277 A1 describes the difficulties as follows: “The coil circuitry, in accordance with the coupling part's described arch-shaped path, can exhibit a warping. Preferred, however, is a straight level coil circuitry, for instance, like a conventional circuit board. In this case, the manufacturing is more cost effective. Fact is that there exists a variable distance of the coupling part above the coil circuitry, due to the arch-shaped path. Any arising measuring errors, however, can be avoided by using in this case a heavy-duty, inductive sensor, as, for instance, described in WO-A-03/038379. Also, potential measuring error can be avoided through appropriate calibration.”

The invention does not use any of these three options (arch-shaped inductor sensor, robust flat sensor, calibrated flat sensor), but a flat activator part, opposite to a flat circuit board, as an inductor carrier. Hereby, the difficulties of manufacturing the arch-shapes as well as the measuring errors can be avoided.

### BRIEF DESCRIPTION OF THE DRAWINGS

The invention is described based on FIG. 1 to FIG. 4. Shown in here are:

FIG. 1 a sectional view through an embodiment of a foot pedal module according to the invention;

FIG. 2 a left side view of the foot pedal module according to FIG. 1;

FIG. 3 a right side view of the foot pedal module according to FIG. 1; and

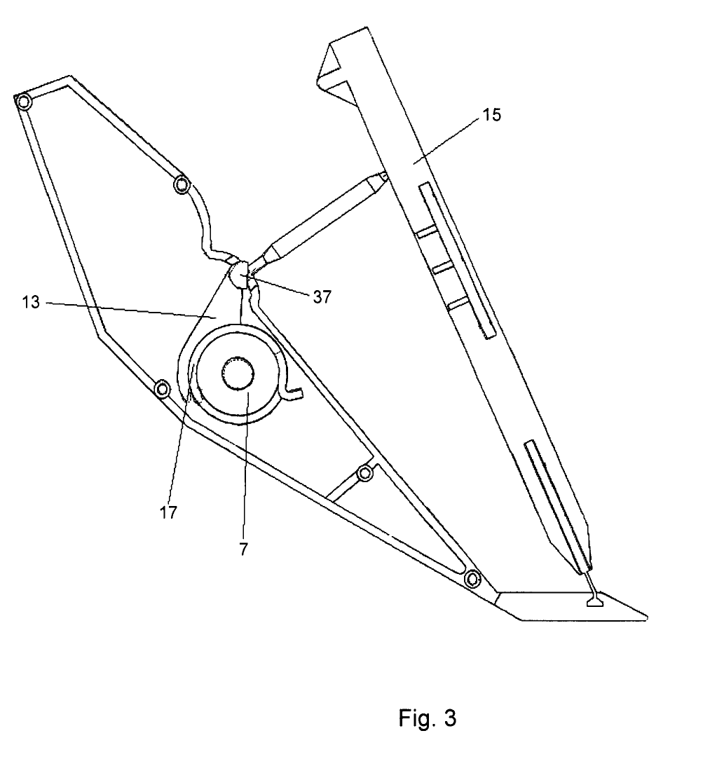

FIG. 4 a perspective view, partially sectioned, of the foot pedal module according to FIG. 1 to 3.

### DETAILED DESCRIPTION OF THE PREFERRED EMBODIMENTS

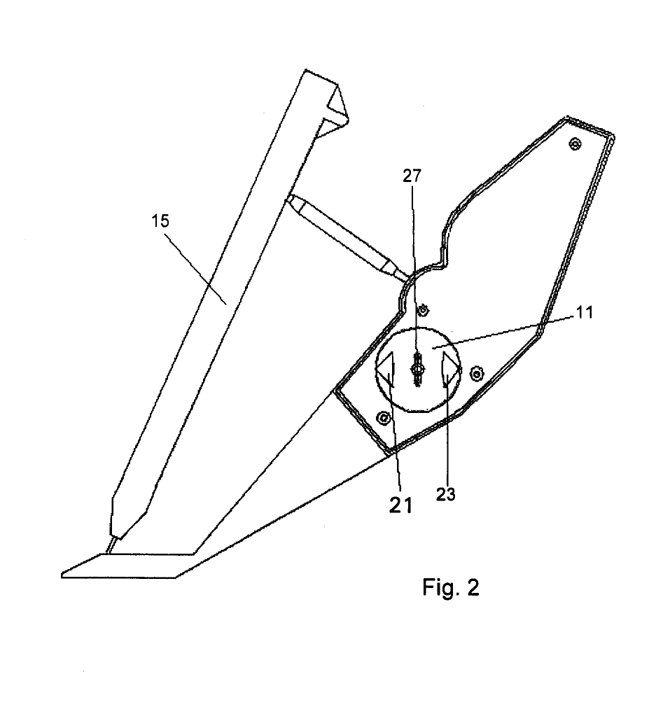

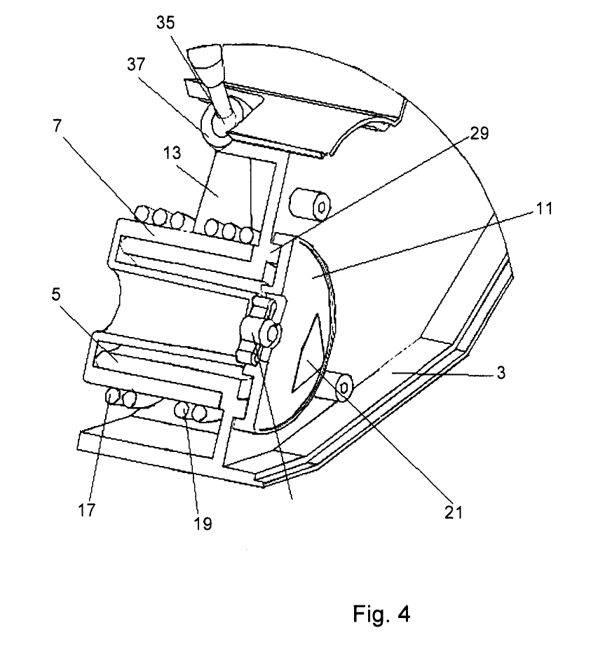

The foot pedal module 1 is protected by the enclosure 3, having an inserted or integrated trunnion 5. On this trunnion, which is firmly connected to the enclosure, a bushing 7 is positioned, which is slipped over the trunnion 5 during the assembly. The bushing 7 comprises (i) a tappet, designed as a driving element 27, for directing the rotor 11, also (ii) a lever 13, through which the distance to be measured, is being precisely transferred from a foot pedal 15 to the rotor 11. Hence, the bushing 7 is driven by the foot pedal 15. The driver generates during the acceleration a certain compressive force on the foot pedal 15. This force will be passed on through a ball joint 35 (details in FIG. 4) and a socket 37 to the lever 13 and the bushing 7. Through pre-stressed springs 17 and 19, a driver experiences the usual resistance when putting pressure on the foot pedal 15. The mentioned driving element 27 (see FIG. 2 and 4) then actuates the rotor 11, which rotates on the enclosure's 3 outer ring 29 (see FIG. 4), in fact rotating exactly in accordance with the deflection of the foot pedal 15. By means of an inductor array 25, an electric signal is ultimately generated by the deflection.

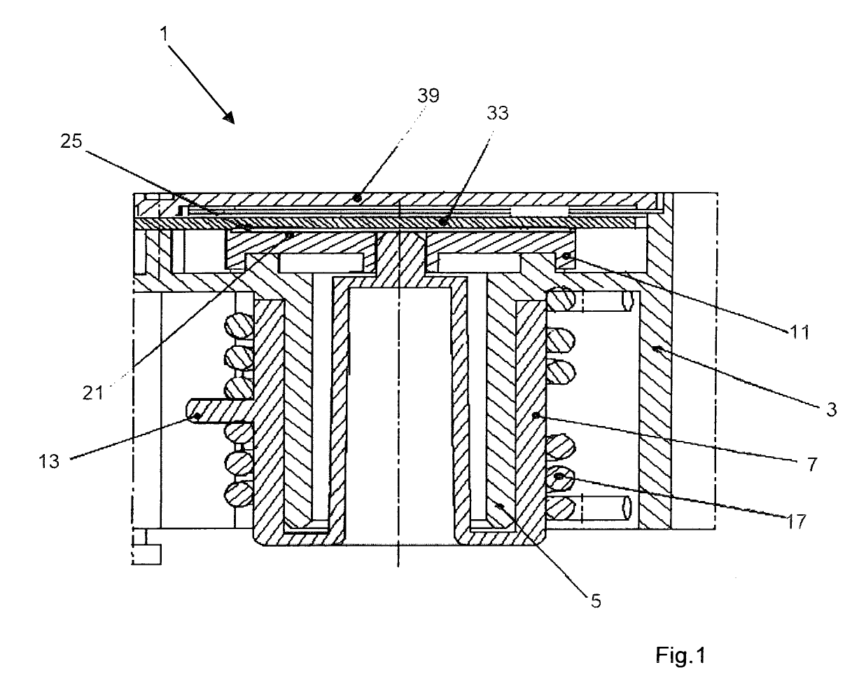

As shown in FIGS. 1, 2, and 4, the rotor 11 is positioned on the enclosure 3, interlocked and driven by the driving element 27. To guarantee a relatively free from play attachment of the rotor 11, the outer ring 29 is molded to the enclosure 3. In addition, a return spring (not shown here) can be positioned between the enclosure's 3 outer ring 29 and the rotor 11, which, in case of a failure of the driving element 27 or failure of any other section of the power train, instantly contributes to having the rotor 11 falling into a position which can be assigned through the coil detection as a definite failure.

The named haptic springs 17, 19 are doubled, for reasons of a reliable redundancy. They define the mechanical resistance which is experienced by the driver when operating the foot pedal 15, meaning that they provide haptic feedback.

The construction of the springs 17, 19 is designed for an equal distribution of the force, approx. 50:50. In case one spring 17, 19 should break, the driver will recognize a loss of force, signaling to the driver that one spring 17, 19 does not function anymore, but the system itself is still working properly.

In case of a deviation from the force's ratio of 50:50, for example at an assumed ratio of 20:80, the driver will most likely notice a force reduction in case the stronger spring would fail, but an non-experienced driver or student driver would not notice a failure of the weaker spring, because the reduction of the force is as little as 20%. For that reason, the force ratio of 50:50 is selected for the two springs 17, 19.

The electric signal conversion takes place based on inductive mode, through the movement of two damping elements 21, 23 (see FIGS. 2 and 4.). The two damping elements 21, 23 are, in relationship to the driving element 27, positioned at the front side of the rotor 11, opposite the corresponding inductor array 25 (see FIG. 2). For this purpose, the damping elements 21, 23 are positioned at the front, opposite of a circuit board 33, containing the related coil array 25. The coil array 25 is designed for the different precision requirements, as well as the planar shape of the related damping elements 21, 23. The second damping element 23 and an opposing coil array 25 are again provided to obtain a dependable redundancy.

### Reference Character Listing:

1 Foot Pedal Module
3 Enclosure
5 Trunnion
7 Bushing
11 Rotor
13 Lever
15 Foot Pedal
17 First Haptic Spring
19 Second Haptic Spring
21 First Damping Element
23 Second Damping Element
25 Inductor Array
27 Driving Element
29 Outer Ring of Enclosure 3
33 Circuit Board
35 Ball Joint
37 Socket
39 Cover of Enclosure 3

1-11. (canceled)

12. A foot pedal module (1) comprising:
an enclosure (3),
a rotor (11),
a foot pedal (15),
two haptic springs (17,19), and
a circuit board (33),
the enclosure (3) exhibiting a trunnion (5), an outer ring (29), and a cover (39) for positioning and protecting the rotor (11), the springs (17, 19) and the circuit board (33), and the rotor (11) being linked to a bushing (7), a lever (13), the two haptic springs (17, 19), two damping elements (21, 23) and a driving element (27),
the circuit board (33) carries an inductor array (25) in a shape and form of flat coils which are positioned opposite the damping elements (21, 23), and the foot pedal (15) which being linked with the lever (13) and the bushing (7) via a ball joint (35) and a socket (37).

13. The foot pedal module (1) according to claim 12, wherein a return spring, which is linked to the bushing (7) and the rotor (11) and which, in case of an interruption of the link (35, 37) between the foot pedal (15) and the lever (13), turns the rotor (11) into a particular error position.

14. A foot pedal module (1) being mechanically connected with a foot pedal (15) through a link (35, 37), the foot pedal module comprising:
an enclosure (3),
a rotor (11),
springs (17, 19), and
a circuit board (33),
a front face of the rotor (11), which is activated by the foot pedal (15), carrying at least one activating element (21, 23), and
the circuit board (33) having coil arrays, designed as flat coils (25) or hall sensors, being positioned opposite, and have at least to the activating element (21, 23) a constant gap.

15. The foot pedal module (1) according to claim 14, wherein the least one activating element is designed as an eddy current damping element (21, 23), which alters an inductance of at least one of the flat coils (25) and, if applicable, a resonant frequency of a related resonant circuit, depending on movement.

16. The foot pedal module (1) according to claim 14, wherein at least one of the activating elements is designed as eddy current damping element (21, 23) which alters a magnetic coupling excitation of at least one of the flat coils with the flat sensor inductor (25) based on motion.

17. The foot pedal module(1) according to claim 14, wherein at least one activating element is a permanent magnet which generates a signal, in the hall sensor, depending on movement and overlap.

18. The foot pedal module(1) according to claim 14, wherein at least one of the springs (17, 19), the activating parts (21, 22), or the inductor array (25), is designed to be redundant.

19. The foot pedal module(1) according to claim 14, wherein the enclosure (3) includes a trunnion (5), an outer ring (29) and a cover (39) for accommodating and protecting the rotor (11), the springs (17, 19), and the circuit boards (21, 23).

20. The foot pedal module (1) according to claim 14, wherein the rotor (11) is linked with a bushing (7), and a driving element (27), and two haptic springs (17, 19), and also features a lever (13) and two damping elements (21, 23).

21. The foot pedal module (1) according to claim 14, wherein the foot pedal (15) is flexibly linked, via a ball joint (35) and a socket (37), with a lever (13) of a bushing (7).

22. The foot pedal module (1) according to claim 14, wherein a return spring engages with of a bushing (7) of the rotor (11) and, in case of an interrupt of the link (35, 37) between the foot pedal (15) and the lever (13), the return spring biases the rotor (11) into a desired position.
